(19) United States
(12) Patent Application Publication
(10) Pub. No.: US 2026/0111744 A1
(43) Pub. Date: Apr. 23, 2026

(54) FINE-TUNING GENERATIVE NEURAL NETWORKS FOR GENERATING DATA ITEMS WITH A TARGET PROPERTY

(71) Applicant: DeepMind Technologies Limited, London (GB)

(72) Inventors: Praneet Dutta, Sunnyvale, CA (US); Ishaan Malhi, Sunnyvale, CA (US); Arunachalam Narayanaswamy, Sunnyvale, CA (US)

(21) Appl. No.: 19/345,874

(22) Filed: Sep. 30, 2025

Related U.S. Application Data
(60) Provisional application No. 63/701,477, filed on Sep. 30, 2024.

(51) Int. Cl. G06N 3/09; G06N 3/0475; G06T 11/60; G06V 10/82; G06V 30/19

(52) U.S. Cl. CPC G06N 3/09; G06N 3/0475; G06T 11/60; G06T 2210/32; G06V 10/82; G06V 30/19

(57) ABSTRACT

Methods, systems, and apparatus, including computer programs encoded on computer storage media, for fine-tuning a generative neural network. For example, the system can fine-tune the generative neural network to more effectively generate data items that have a target property.

### CROSS-REFERENCE TO RELATED APPLICATION

This application claims priority to U.S. Provisional Application No. 63/701,477, filed on Sep. 30, 2024. The disclosure of the prior application is considered part of and is incorporated by reference in the disclosure of this application.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that generates an output data item conditioned on a conditioning input using a generative neural network.

More specifically, this specification describes how a system can fine-tune the generative neural network, e.g., a diffusion neural network, to improve the performance of the generative neural network in accurately generating output data items in response to conditioning inputs that specify respective target values for a particular target property.

Particular embodiments of the subject matter described in this specification can be implemented so as to realize one or more of the following advantages.

Generative models, e.g., diffusion neural networks or other models that generate images, are generally trained on large-scale data sets and, after training, can generate high quality outputs in response to many different inputs. However, even after training, these models can still struggle to generate outputs that accurately represent particular target properties that are provided as part of a conditioning input. For example, a generative model that generates images may struggle to accurately render text that is specified in a conditioning input, even after large-scale training.

Conventional approaches to correcting these issues can require large quantities of labeled data items, e.g., labeled images, that may not be available for all types of properties.

This specification, on the other hand, describes techniques for effectively generating high quality data for fine-tuning the generative neural network to correct issues for particular properties without requiring any a priori labeled data. In particular, this specification describes a pipeline for accurately generating training examples for use in fine-tuning the generative neural network through preference learning without requiring any external input indicating preferences or any labeled data. As a result, the described techniques can be applied to improve the performance of a generative neural network on a variety of generative tasks in a computationally-efficient manner.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example training system and an example data generation system.

FIG. 1B shows an example of the improvements achieved by the described techniques.

FIG. 2 is a flow diagram of an example process for fine-tuning the generative neural network.

FIG. 3 is a flow diagram of another example process for fine-tuning the generative neural network.

Like reference numbers and designations in the various drawings indicate like elements.

### DETAILED DESCRIPTION

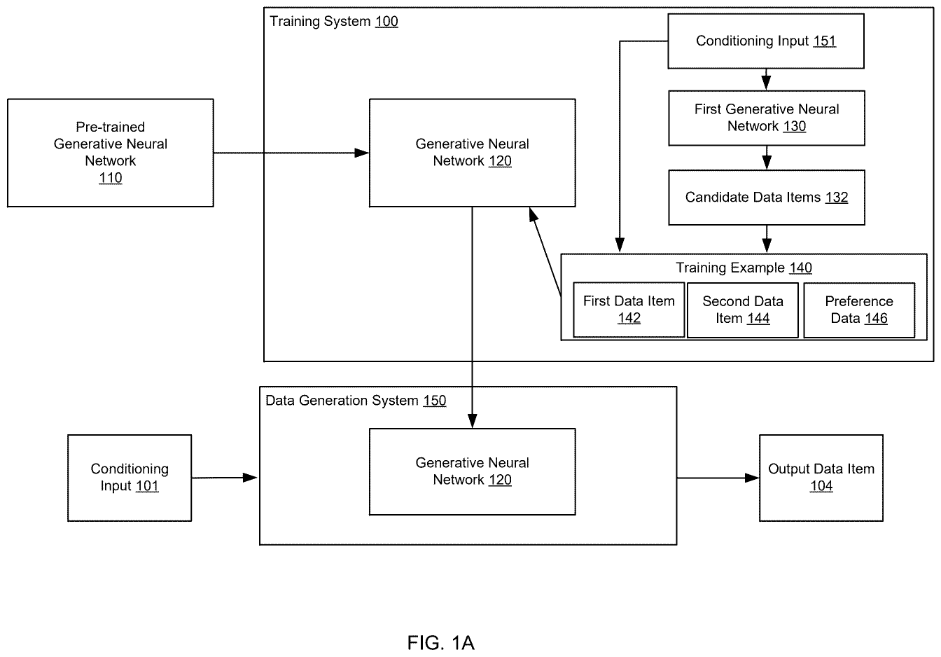

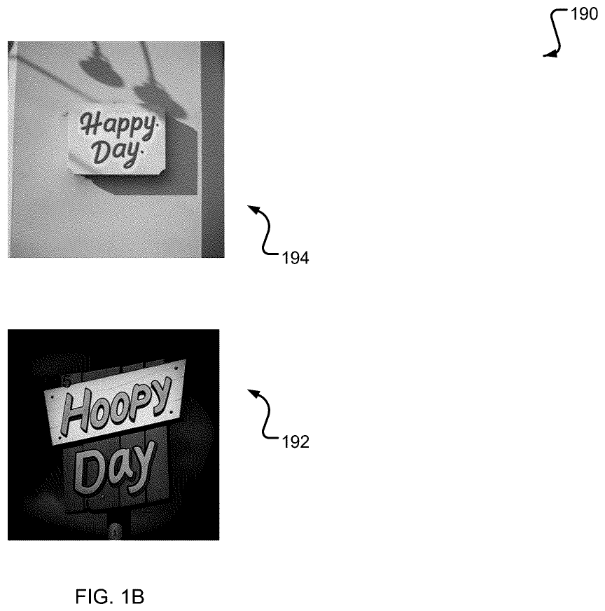

FIG. 1A shows an example training system 100 and an example data generation system 150.

The training system 100 and the data generation system 150 are examples of a system implemented as computer programs on one or more computers in one or more locations, in which the systems, components, and techniques described below can be implemented.

The training system 100 trains a generative neural network 120.

After the training, the data generation system 150 can generate a new data item 104 conditioned on a conditioning input 101 using the generative neural network 120.

In particular, this specification generally describes the generative neural network 120 being a diffusion neural network.

More generally, however, the generative neural network 120 can be any appropriate generative neural network 120 that can map a conditioning input to an output data item, e.g., an auto-regressive generative neural network 120, a non-auto-regressive masked token generation neural network, a normalizing flows model, the generator of a generative adversarial neural network, and so on.

More specifically, the system 100 can fine-tune the generative neural network 120, e.g., the diffusion neural network, to improve the performance of the generative neural network 120 in accurately generating output data items 104 in response to conditioning inputs 101 that specify respective target values for a particular target property.

That is, the system 100 fine-tunes, i.e., further trains, an already-trained generative neural network 110 so that the generative neural network 120 can accurately generate output data items 104 that have target values of a particular target property that are specified in the conditioning input 101.

For example, when the output data items 104 are images, the target property can be rendered content within the image and the target value of the target property can specify a particular item of content to be rendered within the image. Thus, the system 100 trains the generative neural network 120 to accurately generate output images that accurately depict specific items of content that are described by the conditioning input 101.

As one example of this, the target property can be a rendered graphic and the target value of the target property specifies a particular graphic to be rendered within the image.

As another example of this, the target property can be rendered text and the target value of the target property specifies a particular sequence of text to be rendered within the image. Thus, the system 100 trains the generative neural network 120 to accurately generate output images that include accurately rendered text, i.e., legible text that matches text specified in the conditioning input 101.

Other examples of conditioning inputs and data items are described below.

Thus, as described above, the system 100 performs “fine-tuning,” i.e., further training, of the diffusion neural network to improve the performance of the neural network in accurately generating outputs that have values of a particular property that match a value for the property that is specified in the conditioning input.

In other words, prior to being trained by the system 100, the system 100 or another training system has trained the diffusion neural network on a different objective. In general, the diffusion neural network can have been trained conventionally, using any diffusion model objective. As one example, the diffusion neural network can have been trained on a set of training data items on a diffusion score matching objective or a variant thereof.

As a result of this training, the diffusion neural network can generate high-quality data items, e.g., high-quality images or audio, but may have difficulty in accurately aligning the final data item with the corresponding conditioning input when the conditioning input requests a data item that has a specific value for the target property.

For example, the diffusion neural network may be able to generate high-quality images with good aesthetics, but may not be able to consistently accurately render text that is specified by the conditioning input, e.g., may generate text that is illegible or that does not match exactly the text that is specified in the conditioning input. This limits the ability of the system 150 to apply the diffusion neural network to use cases that frequently require generating such data items, e.g., that require generating images with accurately rendered text.

The diffusion neural network can be any appropriate diffusion neural network that is configured to receive an input that includes a current (noisy) representation of an image and a conditioning input and to generate a denoising output.

In some implementations, the diffusion neural network performs a diffusion process in output space, e.g., pixel space when the data items are images. In this example, when the data items are images, the data items (“representations”) operated on and generated by the diffusion neural network have values for each pixel that specify color values, e.g., RGB values or another color encoding scheme.

Examples of such diffusion neural networks include Imagen.

In some other implementations, the diffusion neural network performs a diffusion process in latent space, e.g., in a latent space that is lower-dimensional than the output space. That is, the data items (“representations”) operated on by the diffusion neural network are latent representations and the values in the representations are learned, latent values, e.g., rather than color values when the data items are images.

Examples of such diffusion neural networks include MobileDiffusion, as described in arxiv:2311.16567.

In these implementations, during training, the diffusion neural network can be associated with an encoder to encode training data items into the latent space and, after training and to generate new output data items, a decoder neural network that receives an input that includes a latent representation of a data item and decodes the latent representation to reconstruct the data item.

Performing the further training is described in more detail below.

The diffusion neural network can have any appropriate architecture that allows the neural network to map a diffusion input that includes an input data item that has the same dimensionality as the output data item to a denoising output that also has the same dimensionality as the output data item.

For example, when the output data item is an audio signal or an image, the diffusion neural network can be a convolutional neural network, e.g., a U-Net or other architecture that maps one input of a given dimensionality to an output of the same dimensionality.

As another example, the diffusion neural network can be a Transformer neural network that processes the diffusion input through a set of self-attention layers to generate the denoising output.

The neural network can be conditioned on the conditioning input in any of a variety of ways.

As one example, the system can use an encoder neural network to generate one or more embeddings that represent the conditioning input and the diffusion neural network can include one or more cross-attention layers that each cross-attend into the one or more embeddings.

An embedding, as used in this specification, is an ordered collection of numerical values, e.g., a vector of floating point values or other types of values.

For example, when the conditioning input is text, the system can use a text encoder neural network, e.g., a Transformer neural network, to generate a fixed or variable number of text embeddings that represent the conditioning input.

When the conditioning input is an image, the system can use an image encoder neural network, e.g., a convolutional neural network or a vision Transformer neural network, to generate a set of embeddings that represent the image.

When the conditioning input is audio, the system can use, e.g., an audio encoder neural network, e.g., an audio encoder neural network that has been trained jointly with a decoder neural network as part of a neural audio codec, to generate one or more embeddings that encode the audio.

When the conditioning input is a scalar value, the system can use, e.g., an embedding matrix to map the scalar value or a one-hot representation of the scalar value to an embedding. In some cases, the conditioning input includes multiple different types of inputs, e.g., two or more of text, images, bound values, or context embeddings.

In some of these cases, the system can generate one or more initial embeddings for each of the different types of inputs, i.e., using an appropriate encoder neural network as described above, and then process the initial embeddings for all of the different types of inputs using a Transformer encoder neural network to update each of the initial embeddings to generate a set of final embeddings. The one or more cross-attention layers within the diffusion neural network can then cross-attend into the set of final embeddings.

In others of these cases, different cross-attention layers within the diffusion neural network can cross-attend into embeddings of different types of conditioning inputs.

In yet others of these cases, the system can concatenate the initial embeddings of the different types of inputs along the sequence dimension and then the one or more cross-attention layers can cross-attend into the concatenated set of final embeddings.

As another example, the diffusion neural network can include one or more other types of neural network layers that are conditioned on the one or more embeddings. Examples of such layers include Feature-wise Linear Modulation (FiLM) layers, layers with conditional gated activation functions, and so on.

The diffusion input at any given updating iteration can also include data defining a noise level for the iteration. Generally, each updating iteration has a corresponding time step t and the noise level for the iteration depends on the time step. For example, the noise level can be a decreasing function of the time step t. Examples of such functions include a linear function, a cosine function, and a sigmoid function. In these cases, data identifying the noise level, the time step, or both can be embedded using an appropriate neural network, e.g., a multi-layer perceptron (MLP) and used to condition the diffusion neural network as described above for the conditioning input.

More specifically, to fine-tune the generative neural network 120, the system 100 receives a conditioning input 151 specifying a target value of a target property for a data item. The system 100 then processes the conditioning input 151 using a first generative neural network 130, which can be the same as or different from the generative neural network 120 being trained, to generate one or more candidate data items 132.

For example, the first generative neural network 130 can be the same as the generative neural network 120 being trained or another already-trained generative neural network, e.g., one that is faster to sample from than the generative neural network 120 due to having fewer parameters or requiring fewer sampling steps to generate an output data item.

For each candidate data item 132, the system 100 can determine whether the candidate data item 132 has the target value of the target property.

The system 100 can use this determination to generate one or more training examples 140, with each training example 140 including the conditioning input 151, a first candidate data item 142, and a second candidate data item 144. Each training example 140 also includes preference data 146 that indicates which of the first candidate data item 142 or the second candidate data item 144 is preferred, i.e., in terms of more accurately reflecting the target value of the target property. That is, the system 100 automatically generates preference data 146 for the fine-tuning even though no ground-truth outputs preference data are available to the system 100. Moreover, the system can effectively generate the preference data even though neither the generative neural network 130 nor the generative neural network 120 are able to consistently generate data items that accurately reflect the conditioning input 151.

The system 100 can then train the generative neural network 120 on training data that includes the one or more training examples 140, i.e., that includes the automatically generated preference data 146.

For example, the system 100 can train the generative neural network 120 on a preference learning objective, e.g., a supervised objective that, for each training example 140, is based on which data item in the training example is preferred, i.e., as indicated by the preference data 146. One example of such an objective is the direct preference optimization (DPO) objective.

Another example is the Identity Preference Optimization (IPO) objective.

The system can generate the training examples 140 in any of a variety of ways.

For example, the system 100 can process the conditioning input 151 using the first generative neural network 130 to generate a plurality of candidate data items 132. As described above, the system 100 can then determine whether each candidate data item 132 has the target value of the target property.

In response to determining that a first candidate data item of the plurality of candidate data items 132 has the target value of the target property and that one or more second candidate data items of the plurality of candidate data items 132 do not have the target value of the target property, the system 100 can generate one or more training examples 140, each training example including the conditioning input 151, the first candidate data item 132, and a respective second candidate data item 132 and indicating that the first candidate data item 132 is preferred over the respective second candidate data item 132. Thus, in this example, both the first and second data items in the training examples 140 are generated by the first generative neural network 130 from the same conditioning input 151.

As another example, when the conditioning input 151 specifies a target graphic to be rendered within an output image, the system 100 can process the conditioning input 151 using the first generative neural network 130 to generate one or more candidate output images.

For each candidate output image, the system 100 can determine whether the target graphic was rendered correctly in the candidate output image.

In response to determining that the target graphic was rendered incorrectly in a first candidate output image, the system 100 can generate a second candidate output image by modifying the first candidate output image to replace, with the target graphic, the incorrectly rendered target graphic and generate a training example, the training example including the conditioning input, the first candidate output image, and the second candidate output image and indicating that the second candidate output image is preferred over the first candidate output image.

Thus, in this example, the first data item 142 is generated by the first generative neural network 130 and the second data item 144 is generated by the system 100 by modifying the first data item 142.

Some examples of data items and conditioning inputs now follow.

Generally, the conditioning input characterizes one or more desired properties for the data item, i.e., characterizes one or more properties that the final data item generated by the system should have.

The system can be configured to generate any of a variety of output data items conditioned on any of a variety of conditioning inputs.

For example, the system can be configured to generate audio data, e.g., a waveform of audio or a spectrogram, e.g., a mel-spectrogram or a spectrogram where the frequencies are in a different scale, of the audio.

In this example, the conditioning input can be text or features of text that the audio should represent, i.e., so that the system serves as a text-to-speech machine learning model that converts text or features of the text to audio data for an utterance of the text being spoken.

As another example, the conditioning input can identify a desired speaker for the audio, i.e., so that the system generates audio data that represents speech by the desired speaker.

As another example, the conditioning input can characterize properties of a song or other piece of music, e.g., lyrics, genre, and so on, so that the system generates a piece of music that has the properties characterized by the conditioning input.

As another example, the conditioning input can specify a classification for the audio data into a class from a set of possible classes, so that the system generates audio data that belongs to the class. For example, the classes can represent types of musical instruments or other audio emitting devices, i.e., so that the system generates audio that is emitted by the corresponding class, or types of animals, i.e., so that the system generates audio that represents noises generated by the corresponding animal, and so on.

As another particular example, the data item can be an image, such that the system can perform conditional image generation by generating the intensity values of the pixels of the image. In general the conditioning input can specify one or more characteristics for the image. In this particular example, the conditioning input can be a sequence of text and the output data item can be an image that describes the text, i.e., the conditioning input can be a caption for the output image.

As yet another particular example, the conditioning input can be an object detection input that specifies one or more bounding boxes and, optionally, a respective type of object that should be depicted in each bounding box.

As yet another particular example, the conditioning input can specify an object class from a plurality of object classes to which an object depicted in the output image should belong. As another example, the conditioning input can specify one or more images.

For example, the conditioning input can specify an image at a first resolution and the output data item can include the image at a second, higher resolution.

For example, the conditioning input can specify an image and the output data item can comprise a de-noised, enhanced, stylized, or otherwise edited version of the image.

As yet another particular example, the conditioning input can specify an image including a target entity for detection, e.g., a tumor, and the output data item can comprise the image without the target entity, e.g., to facilitate detection of the target entity by comparing the images.

As yet another particular example, the conditioning input can be a segmentation that assigns each of a plurality of pixels of the output image to a category from a set of categories, e.g., that assigns to each pixel a respective one of the category.

As yet another example, the conditioning input can be a different type of structured input, e.g., a mesh or a graph that specifies properties of the image to be generated.

More generally, the conditioning input can include one or more different types of inputs of one or more different modalities, e.g., only text, only one or more images, both text and one or more images, and so on.

As yet another example, the output data item can be a video. Again the conditioning input can specify one or more characteristics for the video.

As a particular example, the conditioning input can include text and the output data item can be a video described by the text.

As yet another particular example, the conditioning input can include one or more images and the output data item can be a video that completes the one or images, e.g., video starting from the one or more images.

More generally, the task of generating the output data item can be any task that outputs continuous data conditioned on a conditioning input. For example, the output can be an output of a different sensor, e.g., a lidar point cloud, a radar point cloud, an electrocardiogram reading, and so on, and the conditioning input can represent the type of data that should be measured by the sensor. Where a discrete output is desired this can be obtained, e.g., by thresholding the outputs generated by the diffusion neural network.

In some applications, the output data item can be used in a control task to control an action of a mechanical agent acting in a real-world environment to perform a mechanical task. For example, the output data item can be processed by a policy neural network of the agent to select one or more actions to be performed by the agent as part of the task. The agent may then perform the one or more actions. The output data item (e.g., image) can, for example, characterize a state of the real-world environment that is predicted to be obtained by the agent performing the one or more actions. The conditioning input can, e.g., specify a state of the real-world environment and the one or more actions. As another example the conditioning input can specify a state of the real-world environment and the output data item can be used to select one or more actions to be performed by the mechanical agent to perform a task (i.e., the diffusion neural network can represent an action selection policy).

FIG. 1B shows an example 190 of the improvement achieved by the described technique when the output data items are images and the conditioning inputs specify text to be rendered in the output images.

FIG. 1B shows two images: a first image 192 that is produced by the pre-trained generative neural network in response to a text prompt that instructs the model to render the text “Happy day” and second image 194 that is produced by the fine-tuned generative neural network in response to the same text prompt.

As can be seen from FIG. 1B, the first image 192 is generally a high-quality image but incorrectly renders the requested text. That is, the first image 192 does not appear to include any visual flaws, but the text is rendered incorrectly as “Hoopy Day.”

The second image 194, on the other hand, correctly renders the text “Happy Day” while maintaining the high quality of the remaining image. Thus, the system 100 fine-tunes the generative neural network 120 to improve the ability of the generative neural network 120 to accurately render text while still generating high-quality outputs.

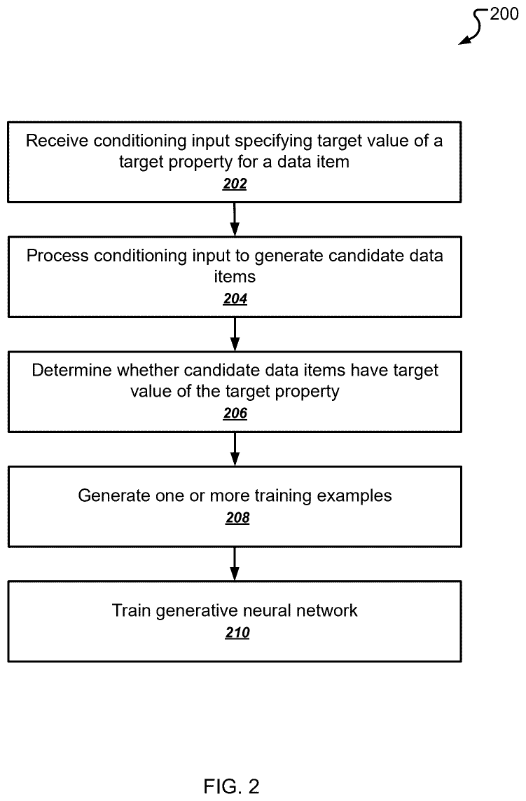

FIG. 2 is a flow diagram of an example process 200 for fine-tuning the generative neural network. For convenience, the process 200 will be described as being performed by a system of one or more computers located in one or more locations.

For example, a training system, e.g., the training system 100 depicted in FIG. 1A, appropriately programmed in accordance with this specification, can perform the process 200. The system receives a conditioning input specifying a target value of a target property for a data item (step 202).

As described above, the conditioning input can be any of a variety of conditioning inputs that correspond to a variety of different properties that the pre-trained generative neural network cannot consistently generate.

As a particular example, when the data items are images, the target property can be rendered content within the image and the target value of the target property can specify a particular item of content to be rendered within the image.

As a more specific example of this, the target property can be a rendered graphic and the target value of the target property can specify a particular graphic to be rendered within the image

As another more specific example of this, the target property can be rendered text and the target value of the target property can specify a particular sequence of text to be rendered within the image.

The system processes the conditioning input using a first generative neural network to generate a plurality of candidate data items (step 204). As described above, this first generative neural network can be the generative neural network that is being fine-tuned or can be a different, already-trained generative neural network.

For each candidate data item, the system determines whether the candidate data item has the target value of the target property (step 206).

The system can determine whether a given candidate data item has the target value in any of a variety of ways.

For example, the system can process an input that includes the candidate data item using a property detector neural network to generate an output that defines a detected value of the target property of the candidate data item and then determines whether the detected value matches the target value. That is, the system can determine whether the property detector neural network detected the target value of the property in the candidate data item.

The property detector neural network can be any of a variety of neural networks. For example, the property detector neural network can be a multi-modal language model neural network and the input to the neural network can also include an instruction to detect a value of the target property of the candidate data item. That is, the system can prompt a general-purpose large scale multi-modal language model to cause the language model to output a detected value of the target property. Examples of such neural networks include those described in Comanici, Gheorghe, et al., Gemini 2.5: Pushing the frontier with advanced reasoning, multimodality, long context, and next generation agentic capabilities. arXiv preprint arXiv:2507.06261 (2025), Gemma Team, et al., Gemma 3 Technical Report arXiv preprint arXiv:2503.19786 (2025), and PaliGemma.

As another example, the property detector neural network can be a neural network that has been trained to detect values of the target property in input data items. That is, the neural network can be one that has been specifically trained to perform the property detection task. For example, when the value specifies text to be rendered in an image, the property detector neural network can be an optical character recognition (OCR) neural network that recognizes text in images.

More generally, when the property value specifies text to be rendered in an image, the system can perform optical character recognition (OCR) on the candidate data item to determine detected text in the image and then determine whether the detected text matches the particular text sequence. The system can use any appropriate OCR technique, e.g., one that uses a neural network or one that performs OCR using statistical image analysis techniques.

In response to determining that a first candidate data item of the plurality of data items has the target value of the target property and that one or more second candidate data items of the plurality of data items do not have the target value of the target property, the system generates one or more training examples (step 208). Each training example includes the conditioning input, the first candidate data item, and a respective second candidate data item. Each training example also includes preference data indicating that the first candidate data item is preferred over the respective second candidate data item, i.e., because the first candidate data item has the target value of the property while the second data item does not.

Although not shown in FIG. 2, if the system determines that all of the data items have the target value of the target property or that none of the data items have the target value of the target property, the system can either (i) perform an additional iteration of steps 204 and 206 to sample additional candidates from the first generative neural network until a set of candidates is identified that satisfies the above criterion or (ii) can refrain from generating any training examples using the conditioning input, i.e., because at this stage of the fine-tuning process, the conditioning input is either too easy or too difficult in order to yield a quality training signal for the generative neural network.

The system trains the generative neural network on training data that includes the one or more training examples (step 210).

For example, the system can train the generative neural network on a supervised objective that, for each training example, is based on which data item in the training example is preferred. For example, the supervised objective can be a direct preference optimization (DPO) objective. As another example, the supervised objective can be an Identity Preference Optimization (IPO).

The training data can also optionally include some or all of the training examples that were used to train the pre-trained generative neural network.

After the training, the system can use the fine-tuned generative neural network as the final neural network to be used to generate data items.

As another example, to preserve the pre-trained capability of the generative neural network while maintaining the improvements resulting from the fine-tuning, the system can generate a final generative neural network by combining the first trained values of the parameters of the generative neural network, i.e., the parameters after the fine-tuning is complete, with pre-trained values of the parameters determined from the pre-training. For example, the system can determine a “model soup” by computing a weighted combination of the first trained values and the pre-trained values.

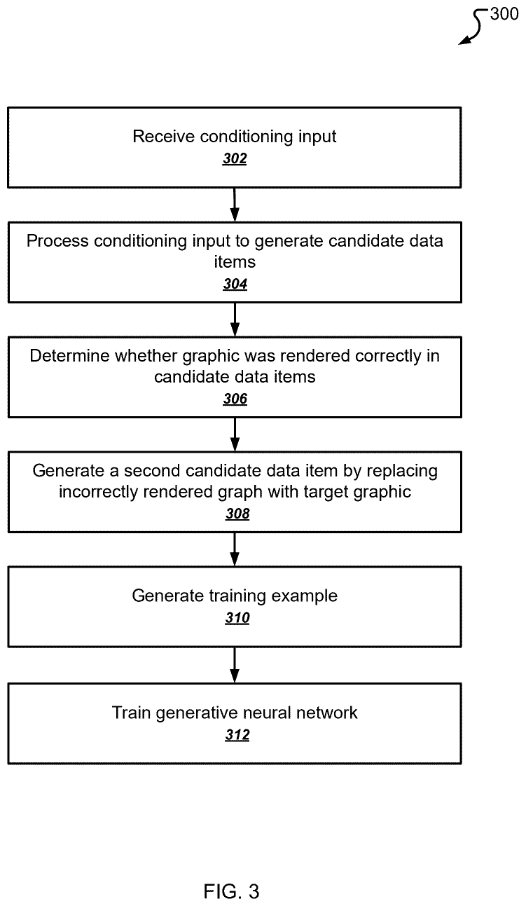

FIG. 3 is a flow diagram of another example process 300 for fine-tuning the generative neural network when the conditioning input specifies a target graphic to be rendered within an output image. For convenience, the process 300 will be described as being performed by a system of one or more computers located in one or more locations.

For example, a training system, e.g., the training system 100 depicted in FIG. 1A, appropriately programmed in accordance with this specification, can perform the process 300. The system receives a conditioning input specifying a target graphic to be rendered within an output image (step 302). The target graphic can be any appropriate type of graphic that could be depicted within a generative neural network. For example, the target graphic can include text that needs to be accurately rendered within the output image.

The system processes the conditioning input using a first generative neural network to generate one or more candidate output images (step 304). As described above, this first generative neural network can be the generative neural network that is being fine-tuned or can be a different, already-trained generative neural network.

For each candidate output image, the system determines whether the target graphic was rendered correctly in the candidate output image (step 306). For example, this can be done using any of the techniques described above with reference to FIG. 2.

In response to determining that the target graphic was rendered incorrectly in a first candidate output image of the candidate output images, the system generates a second candidate output image by modifying the first candidate output image to replace, with the target graphic, the incorrectly rendered target graphic (step 308).

For example, the system can perform in-painting between the target graphic and a modified first candidate output image that excludes a portion of the first candidate output image where the incorrectly rendered target graphic appears. As a particular example, the system can perform in-painting by providing, to an in-painting model, an input that includes the target graphic, the first candidate output image, and a mask or other data that identifies the portion of the first candidate output image where the incorrectly rendered target graphic appears.

To do this, the system can first generate the target graphic in a vector image format, e.g., a scalable vector graphics (SVG) format or other appropriate vector image format.

The system generates a training example that includes the conditioning input, the first candidate output image, and the second candidate output image (step 310). The training example also includes preference data indicating that the second candidate output image is preferred over the first candidate output image.

Although not shown in FIG. 3, if the system determines that all of the data items have the target value of the target property or that none of the data items have the target value of the target property, the system can either (i) perform an additional iteration of steps 304 and 306 to sample additional candidates from the first generative neural network until a set of candidates is identified that satisfies the above criterion or (ii) can refrain from generating any training examples using the conditioning input, i.e., because at this stage of the fine-tuning process, the conditioning input is either too easy or too difficult in order to yield a quality training signal for the generative neural network.

The system then trains the generative neural network on training data that includes the one or more training examples (step 312).

For example, the system can train the generative neural network on a supervised objective that, for each training example, is based on which data item in the training example is preferred. For example, the supervised objective can be a direct preference optimization (DPO) objective. As another example, the supervised objective can be an Identity Preference Optimization (IPO).

The training data can also optionally include some or all of the training examples that were used to train the pre-trained generative neural network.

After the training, the system can use the fine-tuned generative neural network as the final neural network to be used to generate data items.

As another example, to preserve the pre-trained capability of the generative neural network while maintaining the improvements resulting from the fine-tuning, the system can generate a final generative neural network by combining the first trained values of the parameters of the generative neural network, i.e., the parameters after the fine-tuning is complete, with pre-trained values of the parameters determined from the pre-training. For example, the system can determine a “model soup” by computing a weighted combination of the first trained values and the pre-trained values.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities.

Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these.

Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a conditioning input specifying a target value of a target property for a data item;
processing the conditioning input using a first generative neural network to generate a plurality of candidate data items;
for each candidate data item, determining whether the candidate data item has the target value of the target property;
in response to determining that a first candidate data item of the plurality of data items has the target value of the target property and that one or more second candidate data items of the plurality of candidate data items do not have the target value of the target property:
generating one or more training examples, each training example comprising the conditioning input, the first candidate data item, and a respective second candidate data item and indicating that the first candidate data item is preferred over the respective second candidate data item; and
training a second generative neural network on training data that includes the one or more training examples.

2. The method of claim 1, wherein the second generative neural network is the first generative neural network.

3. The method of claim 1, wherein the data item and the candidate data items are images.

4. The method of claim 3, wherein the target property is rendered content within the image and wherein the target value of the target property specifies a particular item of content to be rendered within the image.

5. The method of claim 4, wherein the target property is a rendered graphic and wherein the target value of the target property specifies a particular graphic to be rendered within the image.

6. The method of claim 4, wherein the target property is rendered text and wherein the target value of the target property specifies a particular sequence of text to be rendered within the image.

7. The method of claim 1, wherein the second generative neural network has been pre-trained on different training data prior to the training of the second generative neural network on the training data that includes the one or more training examples.

8. The method of claim 7, wherein training the second generative neural network on the training data comprises training the second generative neural network to determine first trained values of a set of parameters of the second generative neural network, and wherein the method further comprises:
generating a final generative neural network by combining the first trained values of the set of parameters with pre-trained values of the set of parameters determined from the pre-training.

9. The method of claim 7, wherein the training data that includes the one or more training examples further comprises one or more training examples from the different training data.

10. The method of claim 1, wherein the first generative neural network is a diffusion neural network.

11. The method of claim 1, wherein the second generative neural network is a diffusion neural network.

12. The method of claim 1, wherein determining whether the candidate data item has the target value of the target property comprises:
processing an input comprising the candidate data item using a property detector neural network to generate an output that defines a detected value of the target property of the candidate data item; and
determining whether the detected value matches the target value.

13. The method of claim 12, wherein the property detector neural network is a multi-modal language model and wherein the input comprising the candidate data item further comprises an instruction to detect a value of the target property of the candidate data item.

14. The method of claim 12, wherein the property detector neural network is a neural network that has been trained to detect values of the target property in input data items.

15. The method of claim 14, when dependent on claim 6, wherein the property detector neural network is an optical character recognition (OCR) neural network.

16. The method of claim 6, wherein determining whether the candidate data item has the target value of the target property comprises:
performing optical character recognition (OCR) on the candidate data item to determine detected text in the image; and
determining whether the detected text matches the particular text sequence.

17. The method of claim 1, wherein training a second generative neural network on training data that includes the one or more training examples comprises training the second generative neural network on a supervised objective that, for each training example, is based on which data item in the training example is preferred.

18. The method of claim 17, wherein the supervised objective is a direct preference optimization (DPO) objective.

19. The method of claim 17, wherein the supervised objective is Identity Preference Optimization (IPO).

20. A method performed by one or more computers, the method comprising:
receiving a conditioning input specifying a target graphic to be rendered within an output image;
processing the conditioning input using a first generative neural network to generate one or more candidate output images;
for each candidate output image, determining whether the target graphic was rendered correctly in the candidate output image;
in response to determining that the target graphic was rendered incorrectly in a first candidate output image:
generating a second candidate output image by modifying the first candidate output image to replace, with the target graphic, the incorrectly rendered target graphic; and
generating a training example, the training example comprising the conditioning input, the first candidate output image, and the second candidate output image and indicating that the second candidate output image is preferred over the first candidate output image; and
training a second generative neural network on training data that includes the one or more training examples.

21. The method of claim 20, wherein determining whether the target graphic was rendered correctly in the candidate output image comprises:
processing an input comprising the candidate output image using a property detector neural network to generate an output that characterizes a detected graphic within the candidate output image; and
determining whether the detected graphic matches the target graphic.

22. The method of claim 20, wherein generating a second candidate output image by modifying the first candidate output image to replace, with the target graphic, the incorrectly rendered target graphic comprises:
performing in-painting between the target graphic and a modified first candidate output image that excludes a portion of the first candidate output image where the incorrectly rendered target graphic appears.

23. The method of claim 20, further comprising:
generating the target graphic in a vector image format.

24. A system comprising one or more computers and one or more storage devices storing instructions that when executed by the one or more computers cause the one more computers to perform operations comprising:
receiving a conditioning input specifying a target value of a target property for a data item;
processing the conditioning input using a first generative neural network to generate a plurality of candidate data items;
for each candidate data item, determining whether the candidate data item has the target value of the target property;
in response to determining that a first candidate data item of the plurality of data items has the target value of the target property and that one or more second candidate data items of the plurality of candidate data items do not have the target value of the target property:
generating one or more training examples, each training example comprising the conditioning input, the first candidate data item, and a respective second candidate data item and indicating that the first candidate data item is preferred over the respective second candidate data item; and
training a second generative neural network on training data that includes the one or more training examples.
